(19) United States
(12) Patent Application Publication
(10) Pub. No.: US 2021/0362335 A1
(43) Pub. Date: Nov. 25, 2021

(54) ROBOT AND METHOD FOR MANAGE ITEM USING SAME

(71) Applicant: LG ELECTRONICS INC., Seoul (KR)

(72) Inventors: Hyongguk KIM, Seoul (KR); Jaeyoung KIM, Seoul (KR); Hyoungmi KIM, Seoul (KR); Yujune JANG, Seoul (KR)

(21) Appl. No.: 16/489,501

(22) PCT Filed: Jul. 12, 2019
(86) PCT No.: PCT/KR2019/008674

§ 371 Date: Aug. 28, 2019

(51) Int. Cl. B25J 9/16; B25J 11/00; B25J 5/00; B25J 9/00

(52) U.S. Cl. CPC B25J 9/1664; B25J 11/008; B25J 9/1679; B25J 9/0009; B25J 9/161; B25J 5/007; B25J 9/1674

(57) ABSTRACT

Robot according to an embodiment of the present invention includes a base configured to form a main body; an item receiving unit configured to be detached from an upper portion of the base and to have a receiving space receiving an item to be stored therein; a motor providing a driving force for driving; a communication unit configured to receive a call request; and a processor configured to control the motor to move to a position corresponding to a user based on position information included in the call request, and to control the motor to move to a predefined locker station when the item to be stored is received in the item receiving unit from the user.

### FIELD

The present invention relates to a robot, and more particularly, to a robot which manages a user's item in a public place such as an airport or a shopping mall.

### BACKGROUND

A robot is a machine which automatically handles or operates a given task by its own ability, and the robot's application field is generally classified into various fields such as industrial, medical, space, and seabed.

Recently, due to the development of self-driving technology, automatic control technology using a sensor, communication technology, and the like, research for applying a robot to various fields has been continued.

Meanwhile, in public places such as airports, department stores, shopping malls, users generally stay in public places for a predetermined time or more. At this time, users carry a load of a lot of bulky or heavy weight (item).

In a case where If a user holds and moves this item, the mobility of a user may decrease and fatigue thereof may increase. In addition, the user may also be concerned about the loss or theft of item.

The public places have a locker in a predetermined position so that the user's item can be stored for the desired time.

Meanwhile, various people may exist in a building in which a robot is disposed. These people can be mixed with those who have access to certain compartments in the building (apartment buildings/numbers, hotel rooms, or the like) and those who do not have access, such as one-time visitors. For such various people, the spread of the robot can be expanded in a case where a robot capable of providing effective management and customized services is implemented.

### SUMMARY

An object to be solved by the present invention is to provide a robot which can deliver and store the item of the user to the locker station by itself and a method for managing item using the same.

Another object to be solved by the present invention is to provide a robot which delivers a user's item stored in the locker station to the desired position and a method for managing item using the same.

A robot according to an embodiment of the present invention includes a base configured to form a main body; an item receiving unit configured to be detached from an upper portion of the base and to have a receiving space receiving an item to be stored therein; a motor providing a driving force for driving; a communication unit configured to receive a call request; and a processor configured to control the motor to move to a position corresponding to a user based on position information included in the call request, and to control the motor to move to a predefined locker station when the item to be stored is received in the item receiving unit from the user.

The call request may further include information on the item to be stored, and the information may include information on at least one of a kind, a volume, a weight, a quantity, whether to handle care, or a storage temperature of the item to be stored.

The processor may set a driving path based on a current position of the robot and position information included in the call request and control the motor based on the set driving path.

According to an embodiment, the processor may control at least one of a display or a speaker to output a message for inducing receiving of the item, after moving to a position corresponding to the user.

The processor may acquire item storage information on the item to be stored through the communication unit or an input unit, and the item storage information may include at least one of identification information of the user, a password for carrying out the item to be stored, information on a scheduled time for carrying out, or receiving position information.

The item receiving unit in which the item to be stored is received may be separated from the base by a station management robot disposed at the locker station.

The processor may control the motor to move to the locker station based on a carry-out request for the item to be stored, or information on a previously received scheduled time for carrying out of the item to be stored; and control the motor to move to a position corresponding to receiving position information included in the carry-out request or previously received receiving position information, when the item receiving unit in which the item to be stored is received is mounted by the station management robot.

According to an embodiment, the processor may output a message for inducing to carry out the item to be stored from the item receiving unit through a display or a speaker after moving to the position corresponding to the receiving position information.

According to an embodiment, the processor may receive a password for carrying out the item to be stored through an input unit of the item receiving unit, and unlock a cover of the item receiving unit based on the received password.

A method for manage item using a robot according to an embodiment of the present invention includes receiving a robot call request; selecting available one of the robots based on a state of each of the plurality of robots; transmitting call information corresponding to the robot call request to a selected robot; moving the robot receiving the call information to a position corresponding to position information included in the call information; acquiring item storage information for the item to be stored received in the item receiving unit of the robot; and moving the robot to a predefined locker station.

### BRIEF DESCRIPTION OF THE DRAWING

FIG. 1 illustrates an AI device including a robot according to an embodiment of the present invention.

FIG. 2 illustrates an AI server connected to a robot according to an embodiment of the present invention.

FIG. 3 illustrates an AI system including a robot according to an embodiment of the present invention.

FIG. 4 is a conceptual diagram of a robot and a system including the same according to an embodiment of the present invention.

FIG. 5 is a perspective view of a robot according to an embodiment of the present invention.

FIG. 6 illustrates examples of internal compartments of the item receiving unit of the robot illustrated in FIG. 5.

FIG. 7 is a block diagram illustrating a control configuration of a robot according to an embodiment of the present invention.

FIG. 8 is a flowchart illustrating a robot and a method for managing item of a system including the same according to an embodiment of the present invention.

FIG. 9 is a ladder diagram for explaining an operation in which a robot and a system including the same according to an embodiment of the present invention carry an item to be stored by a user to a locker station.

FIGS. 10A through 10B are exemplary diagrams related to operation of processing a robot call request received from a user.

FIG. 11 is an exemplary view related to an operation in which a robot receives an item to be stored from a user.

FIG. 12 is a flowchart for describing an operation of storing and carrying out an item to be stored of a user in a locker station by a robot and a system including the same according to an embodiment of the present invention.

FIGS. 13 to 14 are exemplary views illustrating an operation in which the station management robot separates the item receiving unit from the robot and stores the item receiving unit in the storage area.

FIGS. 15 to 16 are exemplary views illustrating an operation of delivering and providing an item stored in a locker station to a user.

### DETAILED DESCRIPTION OF THE EMBODIMENTS

Hereinafter, embodiments disclosed herein will be described in detail with reference to the accompanying drawings. It should be understood that the accompanying drawings are only for easily understanding the embodiments disclosed in the present specification, the technical spirit disclosed in the present specification is not limited by the accompanying drawings, and all changes and equivalents to substitutes included in the spirit and the technical scope of the present invention are provided.

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyper-parameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

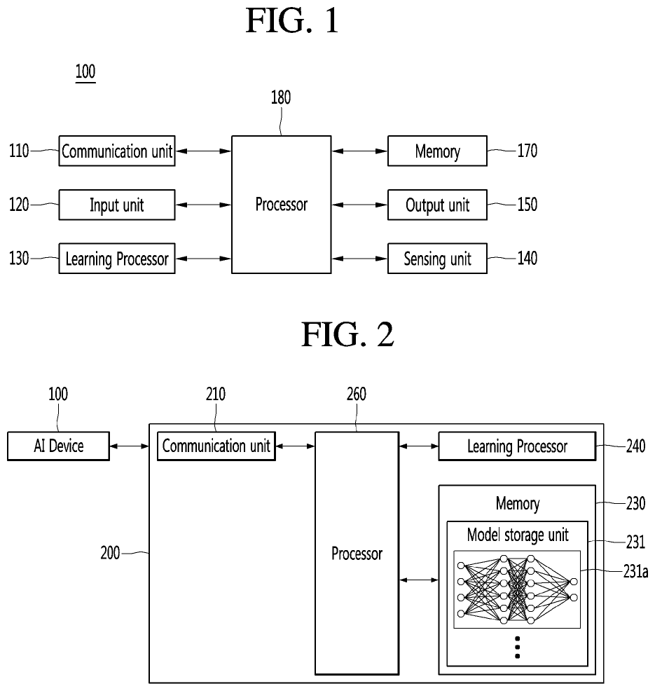

FIG. 1 illustrates an AI device 100 including a robot according to an embodiment of the present invention.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

At this time, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used when an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 connected to a robot according to an embodiment of the present invention.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 can transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

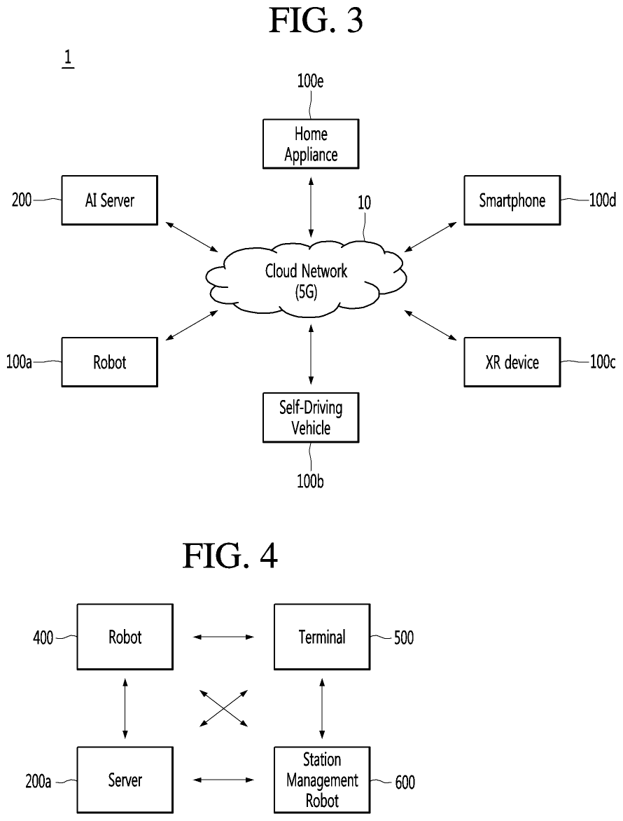

FIG. 3 illustrates an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the driving plan, may determine the response to user interaction, or may determine the operation.

The robot 100a may use the sensor information acquired from at least one sensor among the lidar, the radar, and the camera so as to determine the driving path and the driving plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

FIG. 4 is a conceptual diagram of a robot and a system including the same according to an embodiment of the present invention.

Referring to FIG. 4, a system for performing a method for managing item according to an embodiment of the present invention may include at least one of a robot 400, a server 200a, a terminal 500, and a station management robot 600.

The robot 400 may be disposed in a public place such as an airport or a shopping mall to provide a service for delivering and storing a user's item.

The robot 400 may receive an item which is stored by the user (item to be stored) from the user and may drive to the locker station in a state of receiving the item to be stored. The object to be stored may be safely stored in a locker station. The robot 400 may deliver the item to be stored which are stored in the locker station to the desired position by the user according to a user's request or scheduled time for carrying out and carries out the item to be stored.

The server 200a may manage at least one robot 400 provided in the public place. For example, in a case where a robot call request is received from a user or a terminal 500 of a store, the server 200a may provide the user with the robot 400 currently available among the at least one robot 400. In addition, the server 200a can overall controls the method for managing item according to an embodiment of the present invention based on the information of the users who are stored the item, the information on the item stored by the users, the information on a scheduled time for carrying out the item of the users, and the like.

The server 200a may be managed by an administrator of a public place, an operator of the robot 400, or the like.

According to an embodiment of the present disclosure, the server 200a may correspond to an example of the AI server 200 described above with reference to FIG. 2. In other words, the configuration and contents of the AI server 200 described above in FIG. 2 may be similarly applied to the server 200a.

The terminal 500 may receive a call request of the robot 400 from a user or the like, and transmit the input call request to the server 200a or the robot 400. In addition, the terminal 500 may input a carry-out request for an item from a user or the like and transmit the input request for carrying out to the server 200a or the robot 400.

In addition, the terminal 500 can receive a variety of information such as the position information of the robot 400, the storage status information of the item being stored from the server 200a, the robot 400, or the like and output the received information to provide and thus provide the information to the user.

The terminal 500 may include a terminal (smartphone, tablet PC, or the like.) possessed by a user, or a terminal (for example, a point of sales terminal, or the like) provided in a store of a shopping mall, or the like.

The station management robot 600 may be disposed in a locker station existing at a predetermined position in a public place. In a case where the robot 400 in which the user's item is received arrives at the locker station, the station management robot 600 may separate the item from the robot 400 and store the separated item in a storage area in the locker station.

Meanwhile, the robot 400, the server 200a, the terminal 500, and the station management robot 600 may communicate with each other through a network, or may directly communicate with each other through short-range wireless communication, or the like.

For the convenience of explanation, hereinafter, the robot 400, the terminal 500, and the station management robot 600 are assumed to be able to communicate with each other through the server 200a.

Hereinafter, the configuration of the robot 400 according to an embodiment of the present invention and the embodiments related to the operation of the robot 400 will be described.

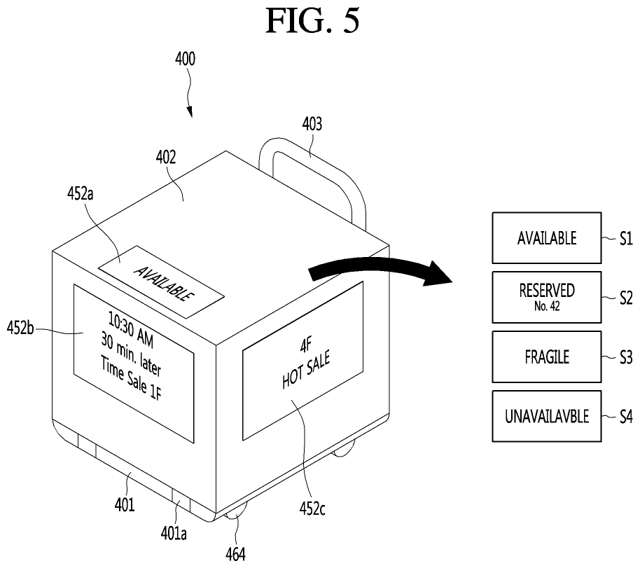

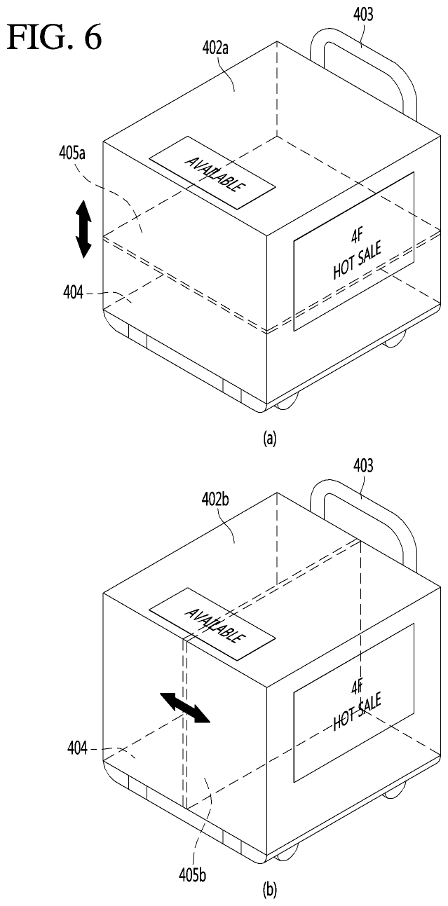

FIG. 5 is a perspective view of a robot according to an embodiment of the present invention. FIG. 6 illustrates examples of internal compartments of the item receiving unit of the robot illustrated in FIG. 5.

Referring to FIG. 5, the robot 400 may include a base 401 forming a main body. For example, the base 401 may be formed in a rectangular plate shape but is not limited thereto. According to an embodiment of the present disclosure, various configurations (for example, a processor, a memory, or the like) related to the control of the robot 400 may be disposed in the base 401.

An upper portion of the base 401 may be provided with an item receiving unit 402 having a receiving space for receiving an item.

For example, the item receiving unit 402 has a rectangular parallelepiped shape and may receive at least one item therein. The user may open a cover formed on an upper surface or one side surface of the item receiving unit 402, and inject an item which is stored in a receiving space (item to be stored) exposed to the outside as the cover is opened.

As illustrated in FIG. 6, the item receiving units 402a and 402b may include a base plate 404 forming a bottom surface. The base plate 404 may be seated or mounted on the base 401 of the robot 400.

At least one compartment plate 405a and 405b is formed in the item receiving units 402a and 402b and can partition storage space into a plurality of spaces.

The user may inject the item into at least one receiving space of the plurality of receiving spaces.

According to an embodiment of the present disclosure, the robot 400 may move the positions of the compartment plates 405a and 405b based on the volume of the item to be stored by the user. To this end, the item receiving unit 402 may be provided with a moving means (not illustrated) for moving the position of the compartment plate 405a and 405b.

Meanwhile, although not illustrated, the item receiving unit 402 may further include a temperature control means (not illustrated) for maintaining or adjusting the temperature of the injected item. For example, the temperature regulating means may include a cooling device for cooling the inside of the receiving space or preventing an increase in the temperature of the received item, and/or a heating device for heating the interior of the receiving space or preventing the temperature reduction of the received item. According to an embodiment of the present disclosure, the item receiving unit 402 may include only one of the cooling device and the heating device. In this case, the robot 400 or the server 200a may provide the user with a robot 400 having a temperature control means corresponding to the type or characteristic of the item to be stored.

Still referring to FIG. 5, the item receiving unit 402 may include at least one display 452a to 452c disposed on the surface. Each of the at least one display 452a to 452c may output a state (such as availability) of the robot 400, information related to a public place where the robot 400 is disposed, advertisement content, and the like.

For example, the first display 452a disposed on the upper surface of the item receiving unit 402 may output the state of the robot 400. For example, the state may include a first state S1 indicating that the robot 400 is available (for example, a state capable of receiving item), a second state S2 indicating that it is reserved by a user's call request, and a third state S3 indicating that item of handling attention is received in the item receiving unit 402, and a fourth state S4 indicating that item of the user is received in the item receiving unit 402 and other users cannot use the item receiving unit.

On the other hand, the item receiving unit 402 may be provided detachably to the base 401.

For example, the item receiving unit 402 may be separated by the station management robot 600. To this end, at least one insertion groove 401a into which the arm 602 (see FIG. 13) of the station management robot 600 is inserted may be formed in the base 401 (or one surface of the item receiving unit 402). The station management robot 600 can insert the arm 602 into the insertion groove 401a and separate the item receiving unit 402 from the base 401 of the robot 400 by an operation such as moving the arm 602 upward. The station management robot 600 may store the item receiving unit 402 and the item therein by placing the separated item receiving unit 402 in a storage area within the locker station.

According to an embodiment of the present disclosure, a terminal may be formed between the base 401 and the item receiving unit 402. The terminal may provide an interface between a control configuration such as a processor in the base 401 and a display 452 and/or temperature adjusting means (not illustrated) in the item receiving unit 402. Accordingly, the processor may control the operation of the configurations in the item receiving unit 402.

According to an embodiment of the present disclosure, various means may be formed in the base 401 such that a movement means (for example, a rail, or the like) for moving the item receiving unit 402 to the outside of the robot 400 is formed.

According to an embodiment of the present disclosure, the robot 400 may further include a holder 403 which allows a user to apply a force to hold or move the robot 400. For example, the holder 403 may be formed to extend upward from one side of the base 401. A bar formed in a horizontal direction is formed on the upper portion of the holder 403, and a user may apply a force to move or stop the robot 400 by holding the bar by hand.

Meanwhile, the robot 400 may include at least one wheel 464 provided on the bottom surface of the base 401. At least one wheel 464 is rotated by the driving force provided from the motor 462 included in the robot 400, thereby enabling the robot 400 to drive.

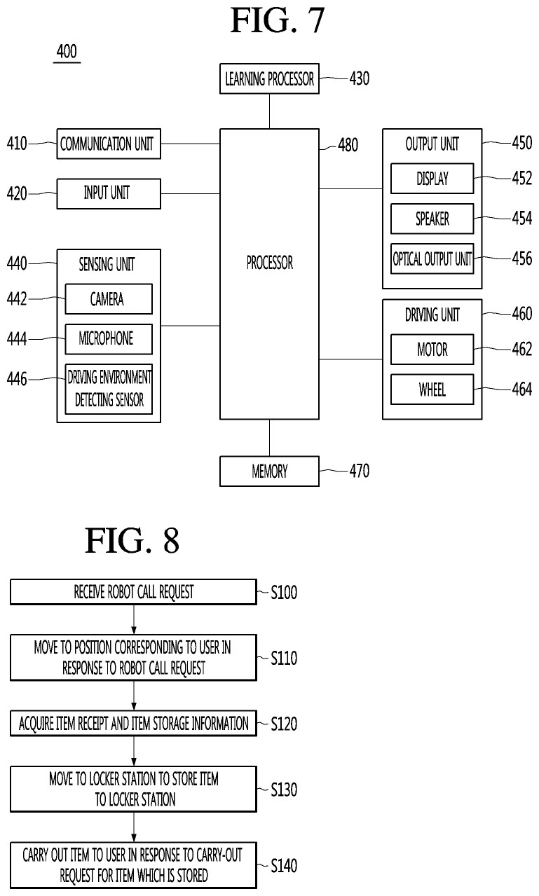

FIG. 7 is a block diagram illustrating a control configuration of a robot according to an embodiment of the present invention.

Referring to FIG. 7, the robot 400 according to an embodiment of the present invention may include a communication unit 410, an input unit 420, a learning processor 430, a sensing unit 440, an output unit 450, and a driving unit 460, memory 470, and processor 480. The configurations illustrated in FIG. 5 are examples for convenience of description, and the robot 400 may include more or fewer configuration than those illustrated in FIG. 5.

Meanwhile, the robot 400 may correspond to an example of the AI device 100 described above with reference to FIG. 1. In this case, the contents of each of the configurations described above in FIG. 1 may be similarly applied to each of the corresponding configurations among the configurations of the robot 400.

The communication unit 410 may include communication modules for connecting the robot 400 to the server 200a, the terminal 500, the station management robot 600, and other robots through a network. Each of the communication modules may support any one of the communication technologies described above with reference to FIG. 1.

For example, the robot 400 may be connected to a network through an access point such as a router. Accordingly, the robot 400 may provide various information and/or data acquired through the input unit 420, the sensing unit 440, or the like to the server 200a through the network.

The input unit 420 may include at least one input means for acquiring various types of data. For example, at least one input means may include a physical input means such as a button or a dial, a touch input unit such as a touchpad or a touch panel. The user may input various requests, commands, information, and the like into the robot 400 through the input unit 420.

The sensing unit 440 may include at least one sensor which senses various information around the robot 400. For example, the sensing unit 440 may include a camera 442, a microphone 444, a driving environment detecting sensor 446, and the like.

The camera 442 may acquire an image around the robot 400. For example, the robot 400 may include at least one camera 442, and the at least one camera 442 may be implemented as a stereo camera, a 2D camera, an infrared camera, or the like.

The microphone 444 may detect sounds (human voice, the sound generated from a specific object, or the like) around the robot 400.

In one example, the processor 480 may acquire image data including the item to be stored through the camera 442, identify the item to be stored based on the acquired image data, or acquire information related to the item to be stored. Alternatively, the processor 480 can transmit the acquired image data to the server 200a through the communication unit 410, and the server 200a can identify the item to be stored or acquire information related to the item to be stored based on the received image data.

According to an embodiment of the present disclosure, the processor 480 may identify item to be stored from the image data or may acquire information related to the item to be stored (for example, volume, weight, storage temperature, or the like) through a model learned by the learning processor 430 in the robot 400. Alternatively, the processor 480 may receive data corresponding to the learned model from the server 200a and store the data corresponding to the learned model in the memory 470, and identify the item to be stored from the image data through the stored data, or acquire information related to the item to be stored.

The driving environment detecting sensor 446 may include at least one sensor which detects obstacles on the periphery of the bottom surface of the robot 400, a step on the bottom surface, or the like for stable driving of the robot 400. For example, the driving environment detecting sensor 446 may include a camera, an ultrasonic sensor, a proximity sensor, or the like.

The processor 480 may control the driving direction or the driving speed of the robot 400 based on the sensing value of the driving environment detecting sensor 446. For example, the processor 480 may detect an obstacle in front of the processor based on the sensing value, set or change a driving path based on the detected obstacle, and control a driving unit 460 (for example, a motor 4620 based on the set or changed driving path.

According to an embodiment of the present disclosure, some of the configurations included in the sensing unit 440 (for example, a camera, a microphone, or the like) may function as the input unit 420.

The output unit 450 may output various information related to the operation or state of the robot 400, various services, programs, applications, or the like, which are executed in the robot 400.

For example, the output unit 450 may include a display 452 and a speaker 454.

The display 452 may output the various information or messages, which are described above in a graphic form. According to an embodiment of the present disclosure, the display 452 may be implemented in the form of a touch screen together with the touch input unit. In this case, the display 452 may function as an input means as well as an output means. The speaker 454 may output the various information or messages in the form of voice or sound.

As illustrated in FIG. 5, the display 452 may include at least one display 452a to 452c disposed on the surface of the item receiving unit 402. The processor 480 may output the state of the robot 400, information related to a public place, advertisement content, and the like through the at least one display 452a to 452c.

The driving unit 460 is for moving (driving) the robot 400 and may include, for example, a motor 462. The motor 462 may be connected to at least one wheel 464 provided under the robot 400 to provide a driving force for driving the robot 400 to the wheel 464. For example, the driving unit 462 may include at least one motor 462, and the processor 480 may control at least one motor 462 to adjust the driving direction and/or the driving speed.

The memory 470 may store various data such as control data for controlling operations of components included in the robot 400 and data for performing operations based on input acquired through the input unit 420 or information acquired through the sensing unit 440.

In addition, the memory 470 may store program data such as a software module or an application executed by at least one processor or controller included in the processor 480.

In addition, the memory 470 according to an embodiment of the present invention can store an image recognition algorithm for identifying the item to be stored or acquiring the related information from the image data including the item to be stored acquired through the camera 442.

In addition, the memory 470 may store an algorithm for adjusting a driving speed or a driving direction based on a sensing value acquired through the driving environment detecting sensor 446.

The memory 470 may include various storage devices such as a ROM, a RAM, an EEPROM, a flash drive, a hard drive, and the like in hardware.

The processor 480 may include at least one processor or controller for controlling the operation of the robot 400. In detail, the processor 480 may include at least one CPU, an application processor (AP), a microcomputer (or a microcomputer), an integrated circuit, an application-specific integrated circuit (ASIC), and the like.

The processor 480 may control the overall operation of the configurations included in the robot 400. In addition, the processor 480 may include an ISP for generating image data by processing an image signal acquired through the camera 442, a display controller for controlling an operation of the display 452, and the like.

Hereinafter, referring to FIGS. 8 to 16, the operation of the robot 400 and a system including the same according to an exemplary embodiment of the present invention will be described in more detail.

FIG. 8 is a flowchart illustrating a robot and a method for managing item of a system including the same according to an embodiment of the present invention.

Referring to FIG. 8, the robot 400 or the server 200a may receive a robot call request from the user (S100).

For example, a user may input a robot call request through an application executed in the terminal 500.

Alternatively, the employee of the store may input the robot call request through the terminal 500 (POS terminal, or the like) when the user purchases and pays for the item.

The terminal 500 may transmit the input robot call request to the server 200a (or the robot 400).

For example, the robot call request may include position information of the user or the store. According to an embodiment of the present disclosure, the robot call request may further include information related to the type or characteristic (volume, weight, storage temperature, or the like) of the item to be stored.

According to an embodiment of the present disclosure, the processor 480 of the robot 400 may receive a robot call request from the user through the input unit 420, the camera 442, and/or the microphone 444. In this case, the robot call request may be received in the form of operation of the input unit 420 (button, touch input unit, or the like), or in the form of a gesture and/or voice.

The robot 400 may move to a position corresponding to the user in response to the robot call request (S110).

For example, the terminal 500 may transmit position information indicating a position corresponding to a user when the robot call request is transmitted. For example, the position information may include the position of a user, a store, or the like.

In a case where the terminal 500 transmits the robot call request and the position information to the server 200a, the server 200a may transmit the robot call request and the position information to the robot 400.

The processor 480 may control the driving unit 460 to move to a position corresponding to the user in response to the received robot call request and position information.

The robot 400 may receive the item to be stored from the user and receive the item to be stored in the item receiving unit 402, and the robot 400 or the server 200a may acquire item storage information related to the item to be stored (S120).

The processor 480 may move to a position corresponding to the user, and then request the user to receive the item to be stored in the item receiving unit 402.

The user may open the cover of the item receiving unit 402 and inject the item to be stored into the receiving space.

Meanwhile, the robot 400 or the server 200a may acquire item storage information related to the item to be stored. For example, a user may input the item storage information through the input unit 420 of the robot 400 or transmit the item storage information to the robot 400 or the server 200a through the terminal 500.

For example, the item storage information may include information (account, or the like) for identifying the owner (user) of the item to be stored, a password for carrying out the item to be stored, information on a scheduled time for carrying out the item to be stored, the receiving location of the item to be stored for carrying out, and the like.

The robot 400 may move to a preset locker station and store the item to be stored in the locker station (S130).

The processor 480 may control the driving unit 460 to move to the locker station after the item to be stored is received in the item receiving unit 402.

In a case where the robot 400 arrives at the locker station, the item receiving unit 402 in which the item to be stored is received may be separated from the robot 400 by the station management robot 600 or the like. The separated item receiving unit 402 can be stored in a storage area within the locker station.

Thereafter, a new item receiving unit in which no item is received may be mounted on the robot 400 and may perform an operation for storing another user's item.

Alternatively, an item receiving unit in which item to be stored of another user is received may be mounted on the robot 400, and the robot 400 may drive to the position of the other user and carry out the item to be stored to the user.

The robot 400 or the server 200a may provide (carry out) the item to be stored to the user in response to the carry-out request for an item which is stored (S140).

In a case where the item storage information includes information on a scheduled time for carrying out, the server 200a may call the robot 400 to the locker station to carry out the item to be stored to the user based on the information on a scheduled time for carrying out.

Alternatively, the server 200a may receive a carry-out request from the user's terminal 500 and call the robot 400 to the locker station to carry out the item to be stored to the user in response to the received carry-out request.

The station management robot 600 may mount the item receiving unit 402 in which the user's item to be stored is received on the robot 400.

The processor 480 of the robot 400 on which the item receiving unit 402 is mounted can control the driving unit 460 to move to the receiving location based on the information of the receiving location which is received together with the preset receiving location or the carry-out request.

In a case where the robot 400 arrives at the receiving location, the processor 480 may request that the user carries out the item to be stored received in the item receiving unit 402. According to an embodiment of the present disclosure, in order to prevent another person from carrying out the item to be stored without authorization, the cover of the item receiving unit 402 may be locked, and the processor 480 may request to input account or password information for the carry-out thereof. The user may input the account or password information through the input unit 420 or the like. In a case where the input information matches the set information, the processor 480 may unlock the item receiving unit 402 so as to carry out the item to be stored.

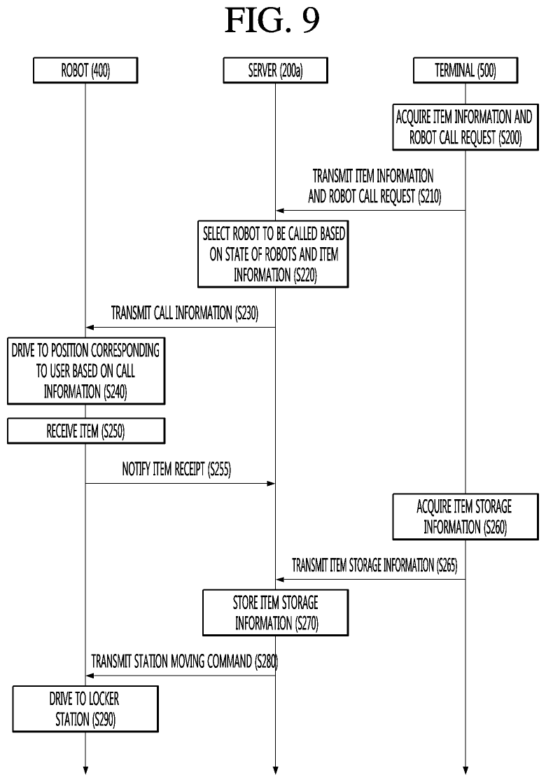

The method for managing item illustrated in FIG. 8 may be implemented in various ways in actual implementation. Hereinafter, some embodiments related to the method for managing item will be described in more detail with reference to FIGS. 9 to 16.

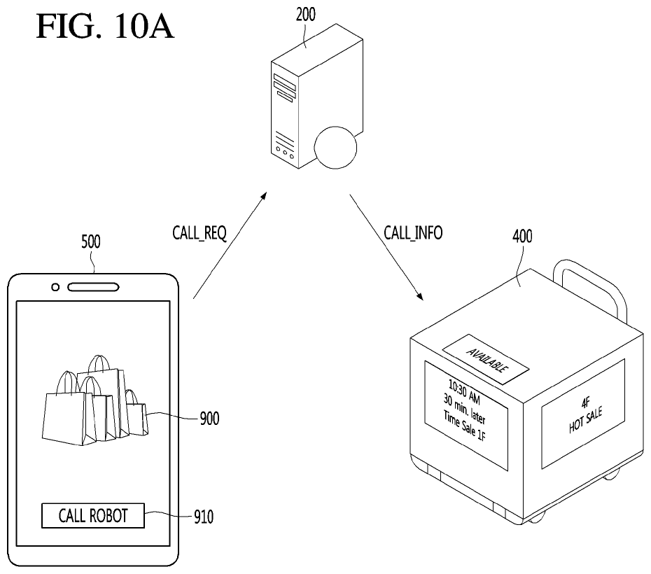

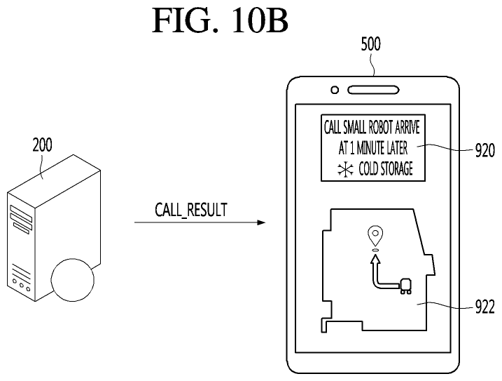

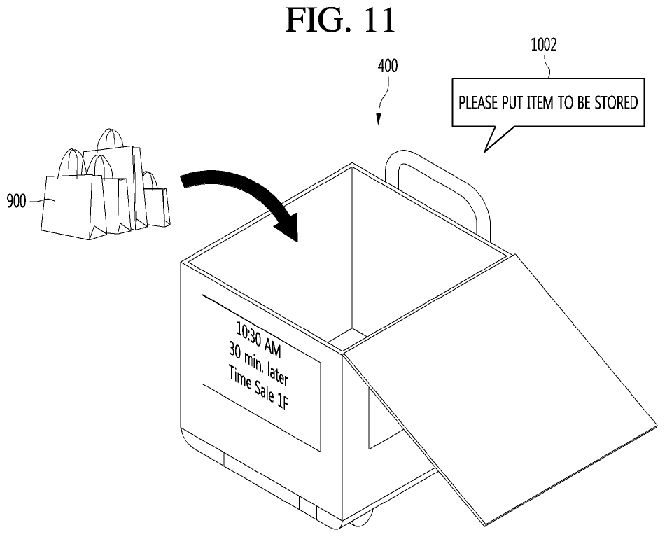

FIG. 9 is a ladder diagram for explaining an operation in which a robot and a system including the same according to an embodiment of the present invention carry an item to be stored by a user to a locker station. FIGS. 10A through 10B are exemplary diagrams related to operation of processing a robot call request received from a user. FIG. 11 is an exemplary view related to an operation in which a robot receives item to be stored from a user.

Referring to FIGS. 9 to 11, the terminal 500 can acquire information on the item to be stored and the robot call request from the user or the like (S200) and can transmit the acquired information and the robot call request CALL_REQ to the server 200a (S210).

The information on the item to be stored may include information on at least one of a kind, a volume, a weight, a quantity, whether to handle care and a storage temperature of the item to be stored.

For example, as illustrated in FIG. 10A, the user may acquire an image including an item 900 to be stored through the camera of the terminal 500. In addition, the user may input the robot call request to the terminal 500 by touching the robot call item 910 displayed on the display of the terminal 500.

The terminal 500 may transmit the robot call request CALL_REQ to the server 200a. At this time, the terminal 500 may transmit an image including the item 900 to be stored together with the robot call request or transmit information on the item 900 to be stored which are extracted from the image to the server 200a. In a case where the image is transmitted to the server 200a, the server 200a may extract information on the item 900 to be stored from the image.

According to an embodiment of the present disclosure, the server 200a may extract information on the item 900 to be stored from the image by using the learning model learned by the learning processor 240.

According to an embodiment of the present disclosure, the terminal 500 may further transmit position information to the server 200a.

The server 200a may select a robot 400 to be called among the robots based on the state of each of the robots 400 and the information on the item to be stored (S220). The server 200a may transmit the call information CALL_INFO to the selected robot 400 (S230).

The server 200a may identify robots which are currently available among robots disposed in a public place. The server 200a may select one robot 400 which can receive the item to be stored, based on the information on the item to be stored, from among the available robots.

For example, the robot having a receiving space larger than the volume of the item to be stored, a robot having a temperature control means for maintaining the storage temperature of the item to be stored, and the like may correspond to the selected robot.

The server 200a may transmit the call information CALL_INFO to the selected robot 400. The call information may include position information of a user, a store, or the like.

The robot 400 may drive to a position corresponding to the user based on the received call information CALL_INFO (S240).

The processor 480 may set a driving path based on the current position of the robot 400 and the position information included in the call information. The processor 480 may move to a position corresponding to the user by controlling the driving unit 460 to drive along the set driving path.

The server 200a may transmit the call result information CALL_RESULT including the information on the robot 400 to be provided to the user, the movement information of the robot 400, and the like to the terminal 500.

The terminal 500 may display the received call result information CALL_RESULT on the display. For example, the terminal 500 may display information 920 on the called robot 400 and movement information 922 of the robot 400.

According to an embodiment of the present disclosure, the server 200a may receive information related to the current position or driving condition from the robot 400 in real-time or periodically, and continuously transmit the received information to the terminal 500.

The robot 400 may receive the item 900 to be stored provided from the user in the item receiving unit 402 (S250), and transmit the item receiving a notification to the server 200a as the item 900 to be stored is received (S255).

The processor 480 may detect that the item 900 to be stored is received as the cover is closed after the cover of the item receiving unit 402 is opened and the item 900 to be stored is received in the receiving space. To this end, the item receiving unit 402 may be provided with a sensor (hall sensor, or the like) for detecting the opening and closing of the cover, or a sensor (distance sensor, weight sensor, or the like) for detecting receiving of the item 900 to be stored.

When the processor 480 detects that the item 900 to be stored is received, the processor 480 may transmit an item receiving a notification to the server 200a.

Meanwhile, the processor 480 may output a message 1002 through the output unit 450 to induce receiving of the item 900 to be stored. For example, the processor 480 may output a message 1002 in the form of voice through the speaker 454.

Meanwhile, the terminal 500 may acquire item storage information for the item to be stored from the user (S260) and may transmit the acquired item storage information to the server 200a (S265).

As described above with reference to FIG. 8, the item storage information includes information for identifying the owner (user) of the item to be stored (account, or the like), a password for carrying out the item to be stored, information on a scheduled time for carrying out the item to be stored, the receiving location of the item to be stored for carrying out, and the like.

The server 200a may store the received item storage information in a memory, a database, or the like (S270).

As the server 200a provides the item management service to the plurality of users, the server 200a may receive and store the item storage information from the plurality of users. In other words, the server 200a may manage storage and carry-out of the item to be stored based on stored item storage information.

When the item receiving notification and the item storage information are received, the server 200a may transmit a station moving command to the robot 400 to move the robot 400 to the locker station (S280).

The robot 400 may drive to a locker station in response to the received station moving command (S290).

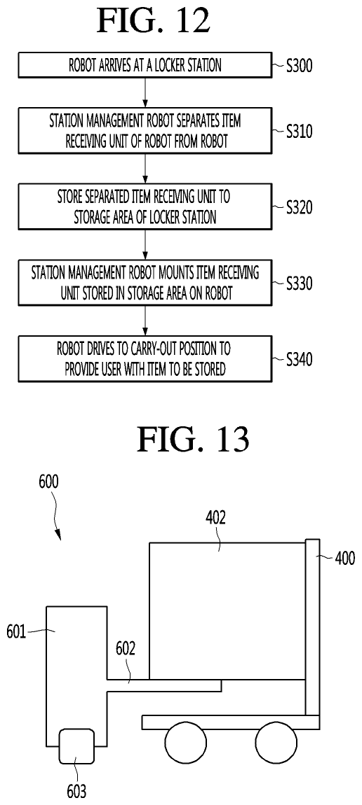

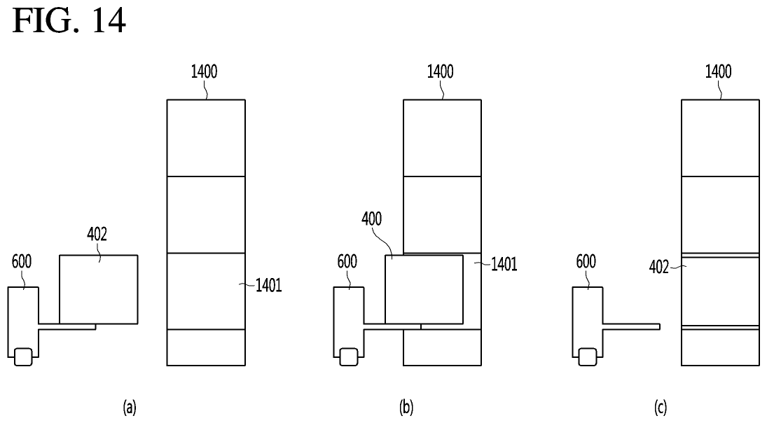

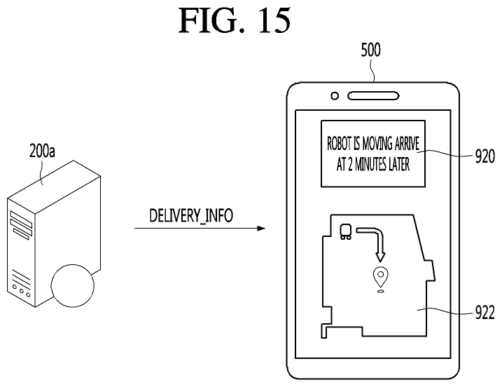

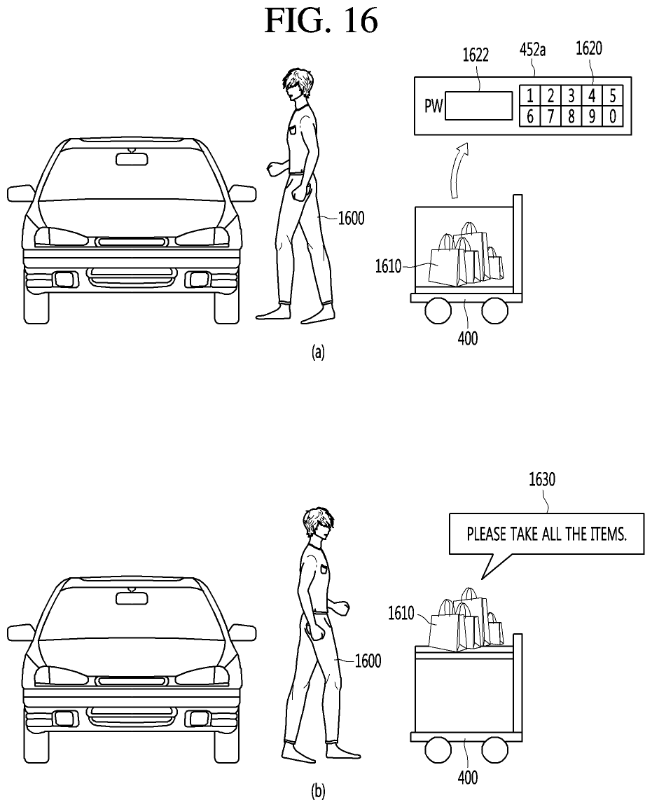

FIG. 12 is a flowchart for describing an operation of storing and carrying out the item to be stored of a user in a locker station by a robot and a system including the same according to an embodiment of the present invention. FIGS. 13 to 14 are exemplary views illustrating an operation in which the station management robot separates the item receiving unit from the robot and stores the item receiving unit in the storage area. FIGS. 15 to 16 are exemplary views illustrating an operation of delivering and providing an item stored in a locker station to a user.

Referring to FIG. 12, the robot 400 may arrive at a locker station in a state where a user's item to be stored is received (S300).

The station management robot 600 may separate the item receiving unit 402 of the robot 400 from the robot 400 (S310), and store the separated item receiving unit 402 in a storage area of the locker station (S320).

For example, in a case where the robot 400 arrives at the locker station, the robot 400 may transmit a signal notifying the arrival to the server 200a or the station management robot 600.

In response to the signal, the server 200a may transmit a control command to the station management robot 600 to separate the item receiving unit 402 of the robot 400.

The station management robot 600 may separate the item receiving unit 402 from the robot 400 based on a signal received from the robot 400 or a control command received from the server 200a.

The station management robot 600 may store the item receiving unit 402 by placing the separated item receiving unit 402 in a storage area in the locker station.

In this regard, referring to FIGS. 13 to 14. the station management robot 600 may insert an arm 602 into an insertion groove 401a (see FIG. 5), and then move the arm 602 upward. Accordingly, the item receiving unit 402 can be separated from the base 401.

For example, the station management robot 600 may detect a position of the insertion groove 401a using a sensor such as a camera and insert the arm 602 into the insertion groove 401a based on the detected position.

Alternatively, the robot 400 may be positioned to face a preset direction at a preset point in the locker station. In this case, since the position of the insertion groove 401a is always constant, the station management robot 600 may insert the arm 602 into the insertion groove 401a without a separate sensor.

Referring to FIGS. 14a to 14c, the station management robot 600 may deliver the item receiving unit 402 to a storage area in the locker station. For example, the storage area may be provided with a locker 1400 for receiving at least one item receiving unit 402.

The station management robot 600 may detect the available receiving space 1401 within the locker 1400 based on the management information of the item receiving units. Alternatively, the station management robot 600 may detect the receiving space 1401 from an image acquired through the camera.

The station management robot 600 can store the item receiving unit 402 in the storage area by injecting the item storage portion 402 into the detected receiving space 1401. According to an embodiment of the present disclosure, the station management robot 600 may generate and store management information including information on the receiving space of the item receiving unit 402 among the receiving spaces of the locker 1400.

The station management robot 600 may mount the item receiving unit 402 stored in the storage area on the robot 400 based on the information on the carry-out request or previously received scheduled time for carrying out (S330).

For example, a user who is using a shopping mall may want to move out of the shopping mall after finishing using the shopping mall. Accordingly, the user may transmit a carry-out request for the item to be stored through the terminal 500 to the server 200a.

The server 200a may transmit the received carry-out request to the station management robot 600 and the robot 400. The carry-out request may include information on the item to be stored, information on the position of receipt of the item to be stored, and the like.

According to an embodiment of the present disclosure, the server 200a may transmit the carry-out request to the station management robot 600 and the robot 400 based on information on a scheduled time for carrying out of the item storage information stored in the memory or the database.

The station management robot 600 may, in response to the received carry-out request, carry out from the storage area the item receiving unit 402 in which the user's item to be stored is received, among the at least one item receiving unit stored in the storage area.

Meanwhile, the robot 400 may move to a preset receiving position in the locker station in response to the received carry-out request. Similar to step S220 of FIG. 9, the server 200a may transmit a carry-out request to any one of the available robots based on the states of the plurality of robots.

When the robot 400 is located at the receiving position, the station management robot 600 may mount the item receiving unit 402 carried out from the storage area on the robot 400.

The robot 400 may drive to a carry-out position to provide a user with the item to be stored (S340).

The processor 480 may set a driving path based on the receiving position information included in the received carry-out request, and control the driving unit 460 based on the set driving path.

For example, the receiving position information may include the carry-out position. The carry-out position may be a current position of the user, a position set by the user, a position where the user's vehicle is parked, and the like.

According to an embodiment of the present disclosure, the processor 480 may transmit position information to the server 200a while the robot 400 moves.

As illustrated in FIG. 15, the server 200a may generate delivery information of the item DELIVERY_INFO based on the position information received from the robot 400, and transmit the generated delivery information DELIVERY_INFO of the user terminal 500.

The delivery information DELIVERY_INFO may include information on the position of the robot 400, the driving path, expected arrival time, and the like. The terminal 500 may display a screen including the information 920 and 922 on the display.

In a case where the robot 400 arrives at the carry-out position, the processor 480 may perform carry-out of the item by providing a user with item to be stored received in the item receiving unit 402.

According to an embodiment of the present disclosure, the processor 480 may request to input password information through the input unit 420 to unlock the cover of the item receiving unit 402 in order to prevent another person from carrying out the item to be stored without authorization.

For example, as illustrated in FIG. 16a, the processor 480 may display a password input screen on the first display 452a (touch screen). The password input screen may include a keypad 1620 and a display window 1622 which displays numbers according to the input of the keypad 1620. The user 1600 may input a password by operating the keypad 1620.

As illustrated in FIG. 16b, in a case where the input password matches the preset password, the processor 480 may unlock the cover. According to an embodiment of the present disclosure, the processor 480 adjusts the position of the compartment plate 405a or the base plate 404 in the item receiving unit 402 so that the user 1600 may easily carry out the item 1610 to be stored, and thus the item to be stored 1610 can also be moved above the receiving space. In addition, the processor 480 may output a message 1630 (for example, a voice message) for inducing the user 1600 to carry out the item 1610 to be stored from the item receiving unit 402 through the output unit 450 (for example, a speaker (454)).

In other words, according to an embodiment of the present invention, the robot 400 and a system including the same are provided with a service for receiving a user's item using a public place such as a department store, a shopping mall or an airport, and storing and managing the item at a locker station. Accordingly, the operator of a public place can prevent space congestion due to the item of users existing in the public place and provide users with a more comfortable environment.

In addition, a user can safely store bulky or heavy item through the service, and can conveniently receive the item at the desired position at the desired time. Therefore, the convenience of the user can be maximized when using a public place.

The foregoing description is merely illustrative of the technical idea of the present invention and various changes and modifications may be made by those skilled in the art without departing from the essential characteristics of the present invention.

Therefore, the embodiments disclosed in the present invention are intended to illustrate rather than limit the technical idea of the present invention, and the scope of the technical idea of the present invention is not limited by these embodiments.

The scope of protection of the present invention should be construed according to the following claims, and all technical ideas falling within the equivalent scope to the scope of protection should be construed as falling within the scope of the present invention.

What is claimed is:

1. A robot comprising:
a base configured to form a main body;
an item receiving unit configured to be detached from an upper portion of the base and to have a receiving space receiving an item to be stored therein;
a motor providing a driving force for driving;
a communication unit configured to receive a call request; and
a processor configured to control the motor to move to a position corresponding to a user based on position information included in the call request, and to control the motor to move to a predefined locker station when the item to be stored is received in the item receiving unit from the user.

2. The robot of claim 1,
wherein the call request further includes information on the item to be stored, and
wherein the information includes information on at least one of a kind, a volume, a weight, a quantity, whether to handle care, or a storage temperature of the item to be stored.

3. The robot of claim 1,
wherein the processor sets a driving path based on a current position of the robot and position information included in the call request and controls the motor based on the set driving path.

4. The robot of claim 1,
wherein the processor controls at least one of a display or a speaker to output a message for inducing receiving of the item, after moving to a position corresponding to the user.

5. The robot of claim 1,
wherein the processor acquires item storage information on the item to be stored through the communication unit or an input unit, and
wherein the item storage information includes at least one of identification information of the user, a password for carrying out the item to be stored, information on a scheduled time for carrying out, or receiving position information.

6. The robot of claim 1,
wherein the item receiving unit in which the item to be stored is received is separated from the base by a station management robot disposed at the locker station.

7. The robot of claim 6,
wherein the processor controls the motor to move to the locker station based on a carry-out request for the item to be stored, or information on a previously received scheduled time for carrying out of the item to be stored; and controls the motor to move to a position corresponding to receiving position information included in the carry-out request or previously received receiving position information, when the item receiving unit in which the item to be stored is received is mounted by the station management robot.

8. The robot of claim 7,
wherein the processor outputs a message for inducing to carry out the item to be stored from the item receiving unit through a display or a speaker after moving to the position corresponding to the receiving position information.

9. The robot of claim 8,
wherein the processor receives a password for carrying out the item to be stored through an input unit of the item receiving unit, and unlocks a cover of the item receiving unit based on the received password.

10. A method for manage item using a robot comprising:
receiving a robot call request;
selecting available one of the robots based on a state of each of the plurality of robots;
transmitting call information corresponding to the robot call request to a selected robot;
moving the robot receiving the call information to a position corresponding to position information included in the call information;
acquiring item storage information for the item to be stored received in the item receiving unit of the robot; and
moving the robot to a predefined locker station.

11. The method for manage item using a robot of claim 10,
wherein in the receiving the robot call request, a server receives the robot call request from a user or a terminal of a store.

12. The method for manage item using a robot of claim 10,
wherein the robot call request includes information on at least one of a kind, a volume, a weight, a quantity, whether to handle care, or a storage temperature of the item to be stored, and
wherein the selecting one of robots is selecting one of robots corresponding to at least one piece of information of the item to be stored, among at least one robot in an available state.

13. The method for manage item using a robot of claim 10,
wherein the position information indicates a position of a user or a store, and
wherein the moving to the position corresponding to the position information included in the call information includes:
setting a driving path based on a current position of the robot and a position corresponding to the position information included in the call request; and
moving based on the set driving path.

14. The method for manage item using a robot of claim 10,
wherein the item storage information includes at least one of identification information of a user, a password for carrying out the item to be stored, information on a scheduled time for carrying out, or receiving position information.

15. The method for manage item using a robot of claim 10, further comprising:
separating the item receiving unit of the robot from the robot by a station management robot disposed at the locker station; and
positioning the separated item receiving unit in a storage area in the locker station.

16. The method for manage item using a robot of claim 15, further comprising:
receiving a carry-out request for the item to be stored;
in response to the received carry-out request, mounting the item receiving unit in which the item to be stored is received located in the storage area on the robot; and
moving the robot on which the item receiving unit is mounted to a position corresponding to receiving position information included in the carry-out request or previously received receiving position information.

17. The method for manage item using a robot of claim 16,
wherein the mounting the item receiving unit to the robot includes
selecting available one of the plurality of robots;
moving the selected robot to the locker station; and
mounting the item receiving unit to the robot moved to the locker station.

18. The method for manage item using a robot of claim 16, further comprising:
receiving a password for carrying out the item to be stored; and
in a case where the received password matches a preset password, unlocking a cover of the item receiving unit.

19. The method for manage item using a robot of claim 16, further comprising:
transmitting delivery information to a terminal of a user while the robot moves to a position corresponding to the receiving position information,
wherein the delivery information includes information on at least one of a position, a driving path, or expected arrival time of the robot.

20. The method for manage item using a robot of claim 15, further comprising:
mounting the item receiving unit in which the item to be stored is received located in the storage area on the robot based on predetermined information on a scheduled time for carrying out for the item to be stored; and
moving the robot on which the item receiving unit is mounted to a position corresponding to receiving position information included in the carry-out request or previously received receiving position information.
